(19) United States
(12) Patent Application Publication
(10) Pub. No.: US 2026/0326274 A1
(43) Pub. Date: Oct. 22, 2026

(54) TOOL FOR CONNECTING HOSE AND CONNECTOR

(71) Applicant: Hokchun LUO, Dongguan (CN)

(72) Inventor: Hokchun LUO, Dongguan (CN)

(21) Appl. No.: 19/648,371

(22) Filed: Apr. 15, 2026

Related U.S. Application Data
(63) Continuation-in-part of application No. 19/232,896, filed on Jun. 10, 2025.

(51) Int. Cl. B25B 27/10; B25B 1/10; B25B 5/10; B25B 5/14; B25B 5/16; B25B 1/20; B25B 1/24

(52) U.S. Cl. CPC B25B 27/10; B25B 1/103; B25B 5/102; B25B 5/147; B25B 5/166; B25B 1/20; B25B 1/2405; Y10T 29/5367; Y10T 29/53687

(57) ABSTRACT

A tool for connecting a hose and a connector, including: a base, a hose clamping assembly, a connector clamping assembly and a drive assembly. The base defines an assembly axis. The hose clamping assembly is slidably connected to the base. The connector clamping assembly is rotatably connected to the base for rotation about the assembly axis. The drive assembly drives the connector clamping assembly, such that the connector clamping assembly rotates about the assembly axis while moving toward or away from the hose clamping assembly. During use, the drive assembly drives the connector clamping assembly to rotate about the assembly axis while simultaneously move toward or away from the hose clamping assembly, such that the connector synchronously completes axial advancement. This composite motion mode of “rotation + linear feed” significantly shortens the assembly time and is particularly suitable for rapid assembly scenarios that require precision.

### CROSS-REFERENCE TO RELATED APPLICATIONS

The present disclosure is a continuation in part application of publication number US 20250303539 A, filed on Jun. 10, 2025, the entire contents of which are hereby incorporated by reference in their entirety.

### TECHNICAL FIELD

The present disclosure relates to the technical field of hand-operated mechanical equipment, in particular to a tool for connecting a hose and a connector.

### BACKGROUND

With the development of society, a large number of hoses and various connectors attached thereto are widely used in daily life. However, the connection between various types of hoses and connectors has become a challenging issue.

At present, the installation auxiliary tools available on the market that are used for positioning connectors (such as joint nuts) are mostly of fixed dimensions and cannot be adjusted. However, connectors produced by different manufacturers exhibit dimensional tolerances and lack a unified standard. This results in the circumstance that nuts from certain brands cannot be inserted into the device, thereby causing the product to have limited applicability. Moreover, most installation auxiliary tools currently available on the market lack a device for clamping the hose and comprise only a device for positioning the connector, rendering installation inconvenient and prone to misalignment. At the same time, the installers currently available on the market also lack a device for assisting the advancement of the connector toward the hose, such that the connector must be installed onto the hose by manual force or with the aid of other auxiliary tools.

### SUMMARY

In order to overcome the deficiencies of the prior art, the present disclosure provides a tool for connecting a hose and a connector. The tool has a simple structure and includes a connector clamping assembly and a drive assembly that provide assistance in advancing the connector toward the hose, as well as a hose clamping assembly for clamping the hose. The connector clamping assembly and the hose clamping assembly are adaptable to connectors and hoses of different specifications, thereby further enhancing the user experience.

To realize the above objective, the present disclosure provides a tool for connecting a hose and a connector, including: a base defining an assembly axis; a hose clamping assembly slidably connected to the base; a connector clamping assembly rotatably connected to the base for rotation about the assembly axis; and a drive assembly configured to drive the connector clamping assembly, such that the connector clamping assembly rotates about the assembly axis while moving toward or away from the hose clamping assembly.

Preferably, the connector clamping assembly comprises a clamping housing, the drive assembly comprises a drive screw, the base comprises a base threaded hole; the clamping housing is fixedly connected to the drive screw, and the drive screw is rotatably connected to the base threaded hole; when the drive screw rotates, the clamping housing drives the connector clamping assembly to rotate about the assembly axis while moving toward or away from the hose clamping assembly.

Preferably, the connector clamping assembly further comprises a first clamping piece and a second clamping piece, the clamping housing comprises a fixed housing, an upper active housing and a lower active housing; the upper active housing and the lower active housing are respectively slidably connected to upper and lower sides of the fixed housing, and the upper active housing and the lower active housing slide synchronously in opposite directions; the first clamping piece is connected to the upper active housing and slides synchronously therewith, the second clamping piece is connected to the lower active housing and slides synchronously therewith, and the first clamping piece and the second clamping piece are configured to fix the connector.

Preferably, the clamping housing further comprises a first adjusting component, the first adjusting component is rotatably connected to the upper active housing and the lower active housing, and the first adjusting component is configured to control the upper active housing and the lower active housing to move toward or away from each other by rotation.

Preferably, the first adjusting component comprises a first thread portion and a second thread portion, the first thread portion is rotatably connected to the upper active housing, the second thread portion is rotatably connected to the lower active housing; and thread directions of the first thread portion and the second thread portion are opposite; when the adjusting component rotates, the upper active housing and the lower active housing move toward or away from each other synchronously.

Preferably, the clamping housing further comprises a first limiting component, the first adjusting component further comprises an axis limiting portion, the first thread portion and the second thread portion are respectively disposed at two ends of the axis limiting portion; the first adjusting component and the first limiting component are rotatably connected via the axis limiting portion, and the first limiting component and the axis limiting portion cooperate with each other to restrict axial movement of the first adjusting component during rotation.

Preferably, the upper active housing is provided with a first threaded through hole, the lower active housing is provided with a second threaded through hole; the first thread portion is cooperated with the first threaded through hole to realize rotatable connection to the upper active housing, and the second thread portion is cooperated with the second threaded through hole to rotatably connect to the lower active housing.

Preferably, the first adjusting component further comprises a gripping portion and a controlling portion, the controlling portion extends from one end of the first adjusting component through either the first threaded through hole or the second threaded through hole, the gripping portion is fixedly connected to the controlling portion, and the gripping portion is configured to control the first adjusting component to rotate.

Preferably, the controlling portion is provided with a connecting threaded hole, the gripping portion is provided with a threaded fastener that matches the connecting threaded hole; and the threaded fastener is threadedly engaged with the connecting threaded hole, such that the gripping portion is securely fixed to the controlling portion.

Preferably, the upper active housing is provided with an upper sliding groove, the lower active housing is provided with a lower sliding groove, the fixed housing is provided with two slide blocks; and the upper sliding groove and the lower sliding groove are configured to cooperate with the two slide blocks, respectively, allowing the upper active housing and the lower active housing to be slidably mounted on upper and lower sides of the fixed housing, respectively.

Preferably, the first clamping piece is fixed to the upper active housing and the second clamping piece is fixed to the lower active housing, each by a threaded connection.

Preferably, the axis limiting portion comprises a connecting shaft section rotatably connected to the first limiting component and limiting shaft sections located at both ends of the connecting shaft section.

Preferably, a diameter of the connecting shaft section is smaller than that of the limiting shaft sections.

Preferably, the first limiting component comprises a limiting through slot, and the connecting shaft section and the limiting shaft sections respectively cooperate with the limiting through slot, such that the first limiting component is rotatably connected to the first adjusting component while restricting axial movement of the first adjusting component.

Preferably, positions of the upper active housing and the lower active housing remain symmetric with respect to the assembly axis at all times during sliding.

Preferably, the drive assembly further comprises a drive handle movably connected to the drive screw, and the drive handle is configured to drive the drive screw to rotate.

Preferably, the drive screw comprises a threaded drive portion and a handle mounting portion, the handle mounting portion is provided with a handle mounting hole; the drive handle comprises a connecting portion and grip limiting portions, the grip limiting portions are located at both ends of the connecting portion, and the connecting portion is movably connected to the handle mounting hole.

Preferably, the hose clamping assembly comprises a second adjusting component, a first clamping component and a second clamping component, the base comprises a guide rail, the guide rail is arranged perpendicular to the assembly axis, the first clamping component and the second clamping component are slidably connected to the guide rail, and the second adjusting component is configured to adjust a distance between the first clamping component and the second clamping component.

Preferably, the hose clamping assembly further comprises a second limiting component, the second limiting component is disposed between the first clamping component and the second clamping component, and the second limiting component is configured to restrict movement of the second adjusting component in a direction parallel to the guide rail; the first clamping component comprises a first threaded hole, the second clamping component comprises a second threaded hole, the second adjusting component comprises a third thread portion and a fourth thread portion, the third thread portion is threadedly connected to the first threaded hole, the fourth thread portion is threadedly connected to the second threaded hole, and thread directions of the third thread portion and the fourth thread portion are opposite.

Preferably, the second adjusting component further comprises a limiting annular groove disposed between the third thread portion and the fourth thread portion; and the second limiting component comprises a connection end and a limiting end, the connection end is fixedly connected to the base, and the limiting end matches part of an outer contour of the limiting annular groove; and the second adjusting component further comprises a control handle, and the control handle is configured to control the second adjusting component to rotate, thereby controlling the first clamping component and the second clamping component to move toward or away from each other.

The beneficial effects of the present disclosure are as follows: during use, the drive assembly is capable of driving the connector clamping assembly to rotate about an assembly axis α while simultaneously move toward or away from the hose clamping assembly in the axial direction, such that the connector synchronously completes axial advancement during the rotation process. This composite motion mode of “rotation + linear feed” significantly shortens the assembly time and is particularly suitable for rapid assembly scenarios that require precision. Compared with traditional manual operation, the efficiency is effectively improved. With the assembly axis α serving as the reference, both the rotational movement and the linear movement of the connector clamping assembly are precisely executed along the same axis, thereby ensuring that the abutting end faces of the connector and the hose consistently maintain a minimal coaxiality error and effectively preventing sealing failure or stress concentration caused by angular deviation. The sliding connection design of the hose clamping assembly enables dynamic adjustment of the clamping distance and clamping force according to the thickness of the hose; in cooperation with the rotational feed of the connector, uniform axial pressure loading is achieved, ensuring consistency in the compression amount at the connecting end of the hose, thereby improving the sealing performance and mechanical strength of the connection joint and further enhancing the user experience.

### BRIEF DESCRIPTION OF DRAWINGS

In order to more clearly illustrate the technical solutions in the embodiments of the present disclosure, the drawings required for the description of the embodiments are briefly introduced below. The drawings described in the following are merely some embodiments of the present disclosure. For a person of ordinary skill in the art, other drawings may be obtained from these drawings without creative effort. In addition, the drawings are not drawn to a 1:1 scale, and the relative sizes of the various components are merely illustratively depicted in the drawings and do not necessarily correspond to actual proportions.

The present disclosure will be further described below in conjunction with the accompanying drawings and embodiments.

FIG. 1 is a schematic structural diagram of a tool for connecting a hose and a connector according to an embodiment of the present disclosure, showing the tool in a first viewing angle while the hose is connected to the connector.

FIG. 2 is a schematic structural diagram of the tool for connecting the hose and the connector, at a second angle when connecting the hose and the connector.

FIG. 3 is a first exploded view of the tool for connecting the hose and the connector.

FIG. 4 is a second exploded view of the tool for connecting the hose and the connector.

FIG. 5 is a third exploded view of the tool for connecting the hose and the connector.

FIG. 6 is a fourth exploded view of the tool for connecting the hose and the connector.

FIG. 7 is a partial exploded view of the tool for connecting the hose and the connector.

FIG. 8 is a partial schematic structural diagram of a tool for connecting a hose and a connector.

FIG. 9 is an enlarged view of portion A in FIG. 7;

FIG. 10 is an enlarged view of portion B in FIG. 8.

### DESCRIPTION OF THE REFERENCE NUMERALS

1 hose, 2 connector, 100 base, 200 hose clamping assembly, 300 connector clamping assembly, 400 drive assembly, 110 base threaded hole, 120 guide rail, 210 second adjusting component, 211 third thread portion, 212 fourth thread portion, 213 limiting annular groove, 214 control handle, 220 first clamping component, 221 first threaded hole, 230 second clamping component, 231 second threaded hole, 240 second limiting component, 241 connection end, 242 limiting end, 310 clamping housing, 311 fixed housing, 3111 slide block, 312 upper active housing, 3121 first threaded through hole, 3122 upper sliding groove, 313 lower active housing, 3131 second threaded through hole, 3132 lower sliding groove, 314 first adjusting component, 3141 first thread portion, 3142 second thread portion, 3143 axis limiting portion, 3143a connecting shaft section, 3143b limiting shaft section, 3144 gripping portion, 3144a threaded fastener, 3145 controlling portion, 3145a connecting threaded hole, 315 first limiting component, 3151 limiting through slot, 320 first clamping piece, 330 second clamping piece, 410 drive screw, 411 threaded drive portion, 412 handle mounting portion, 4121 handle mounting hole, 420 drive handle, 421 connecting portion, 422 grip limiting portion.

### DETAILED DESCRIPTION OF THE EMBODIMENTS

To make the above-mentioned objectives, features, and advantages of the present application more apparent and readily understandable, the specific embodiments of the present application are described in detail below in conjunction with the accompanying drawings. In the following description, numerous specific details are set forth in order to provide a thorough understanding of the present application. However, the present application may be implemented in many other ways different from those described herein, and persons skilled in the art may make similar modifications without departing from the spirit of the present application. Therefore, the present application is not limited by the specific embodiments disclosed below.

In the description of the present application, it is to be understood that, when the terms “center,” “longitudinal,” “transverse,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” “circumferential,” and the like appear, the orientation or positional relationship indicated by these terms is based on the orientation or positional relationship shown in the accompanying drawings, merely for the convenience of describing the present application and simplifying the description, and does not indicate or imply that the device or element referred to must have a specific orientation, be constructed and operated in a specific orientation. Therefore, such terms cannot be construed as limiting the present application.

Furthermore, when the terms “first” and “second” appear, these terms are used for descriptive purposes only and cannot be interpreted as indicating or implying relative importance or implicitly specifying the number of the indicated technical features. Accordingly, a feature defined as “first” or “second” may explicitly or implicitly include at least one of the features. In the description of the present application, when the term “plurality” or “multiple” appears, the meaning of “plurality” or “multiple” is at least two, for example two, three, etc., unless otherwise expressly and specifically limited.

In the present application, unless otherwise expressly specified and limited, when the terms “mounted,” “connected,” “coupled,” “fixed,” and the like appear, these terms shall be interpreted in a broad sense. For example, it may be a fixed connection, a detachable connection, or an integral connection; it may be a mechanical connection or an electrical connection; it may be a direct connection or an indirect connection through an intermediate medium; it may be an internal communication between two elements or an interaction relationship between two elements, unless otherwise expressly limited. For those of ordinary skill in the art, the specific meanings of the above terms in the present application may be understood according to specific circumstances.

In the present application, unless otherwise expressly specified and limited, when descriptions such as a first feature being “on” or “under” a second feature or similar descriptions appear, the meaning thereof may be that the first and second features are in direct contact, or that the first and second features are in indirect contact through an intermediate medium. Moreover, the first feature being “above,” “over,” or “on” the second feature may mean that the first feature is directly above or obliquely above the second feature, or merely indicates that the first feature is at a horizontal height higher than that of the second feature. The first feature being “below,” “under,” or “beneath” the second feature may mean that the first feature is directly below or obliquely below the second feature, or merely indicates that the first feature is at a horizontal height lower than that of the second feature.

It should be noted that, if an element is referred to as being “fixed to” or “disposed on” another element, it may be directly on the other element or there may be an intervening element. If an element is considered to be “connected to” another element, it may be directly connected to the other element or there may be an intervening element present. If present, the terms “vertical,” “horizontal,” “upper,” “lower,” “left,” “right,” and similar expressions used in the present application are for illustrative purposes only and do not indicate that they are the only embodiments.

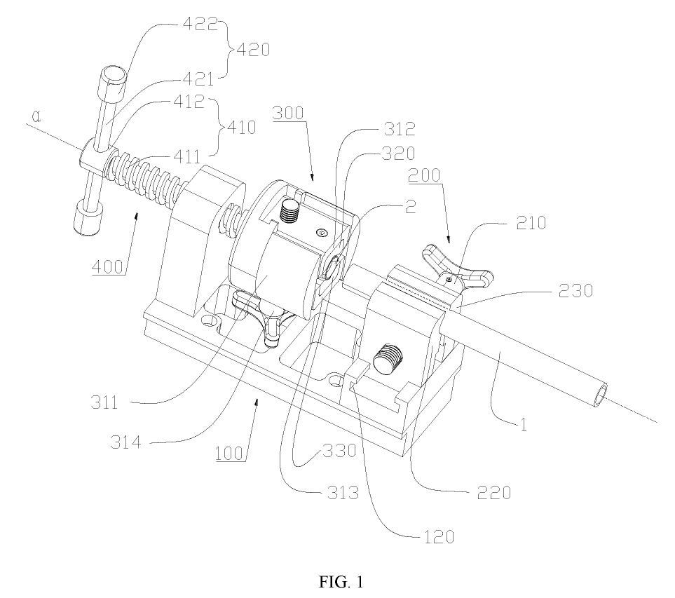

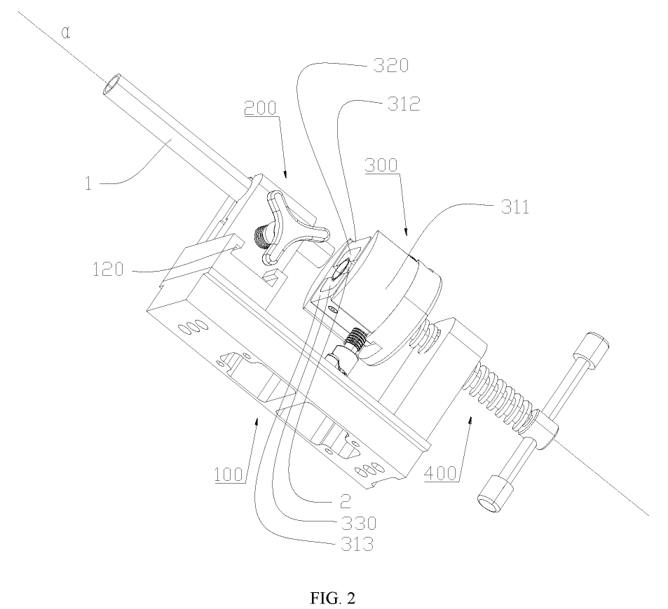

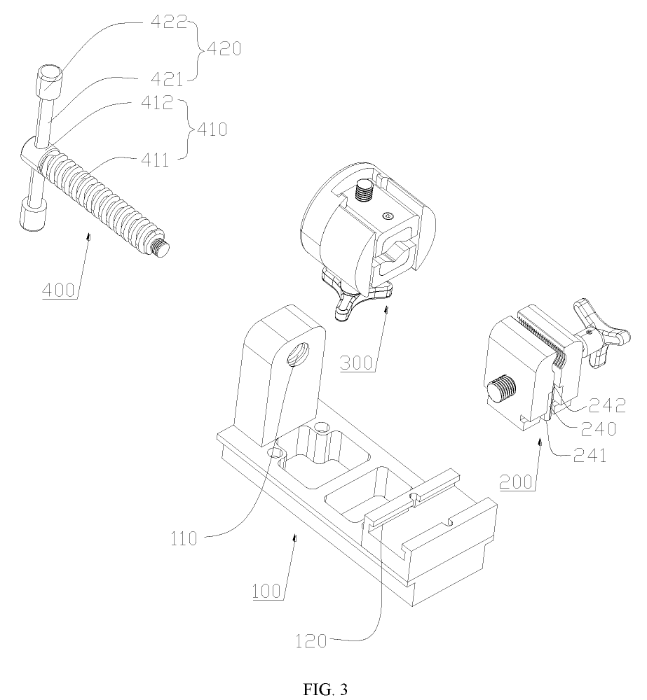

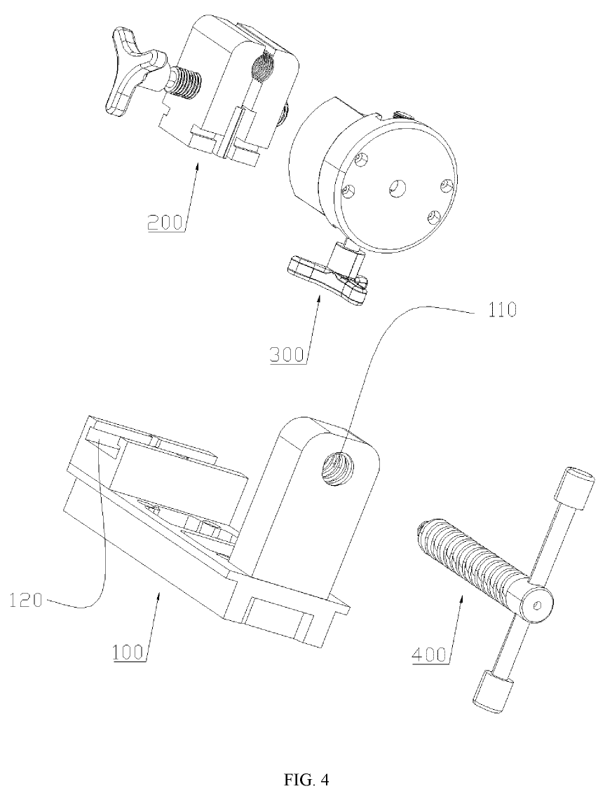

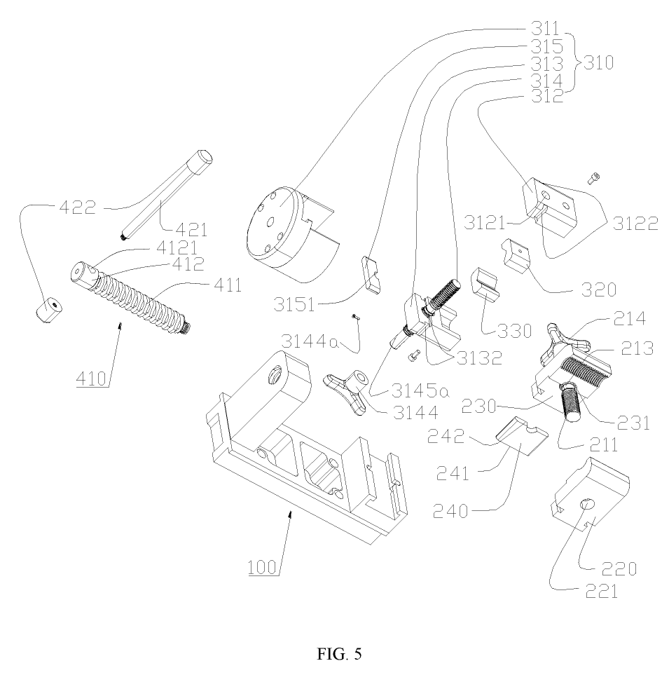

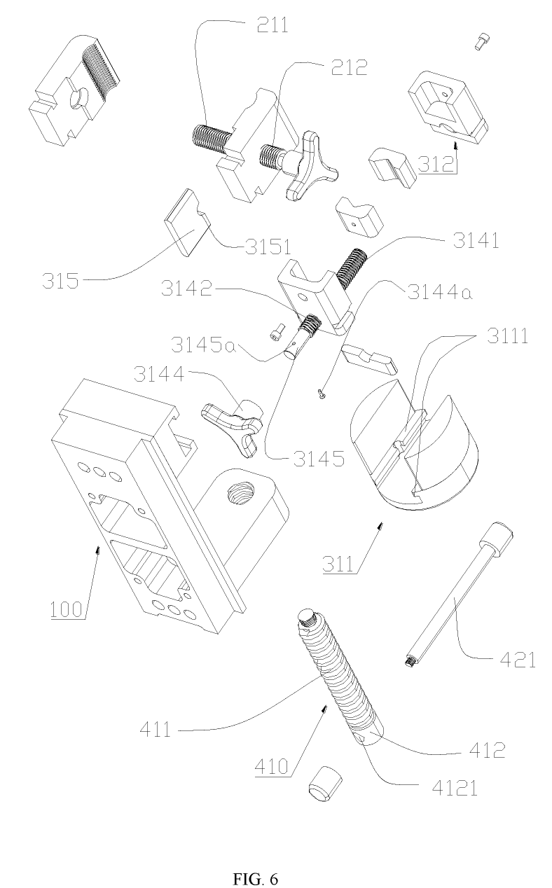

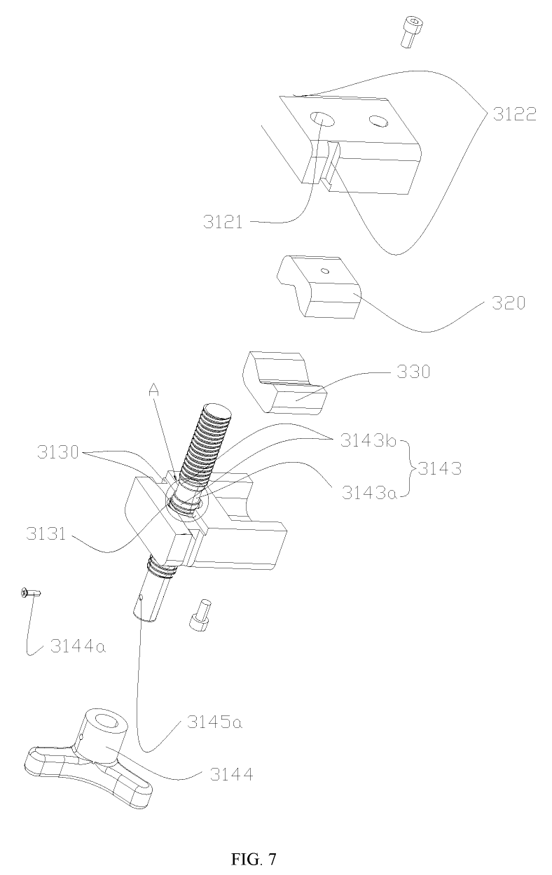

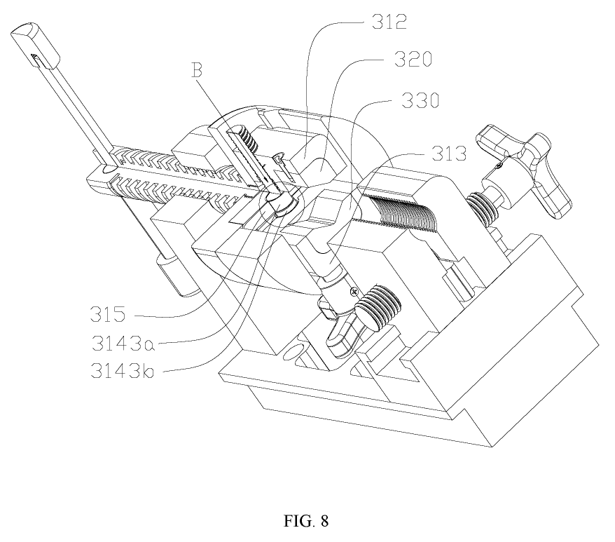

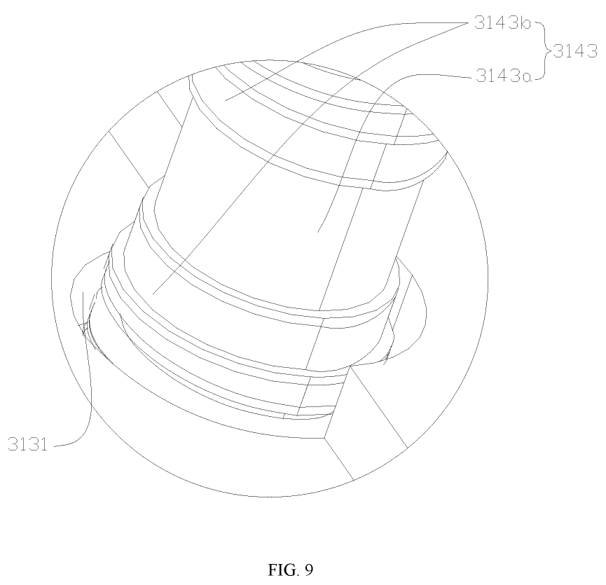

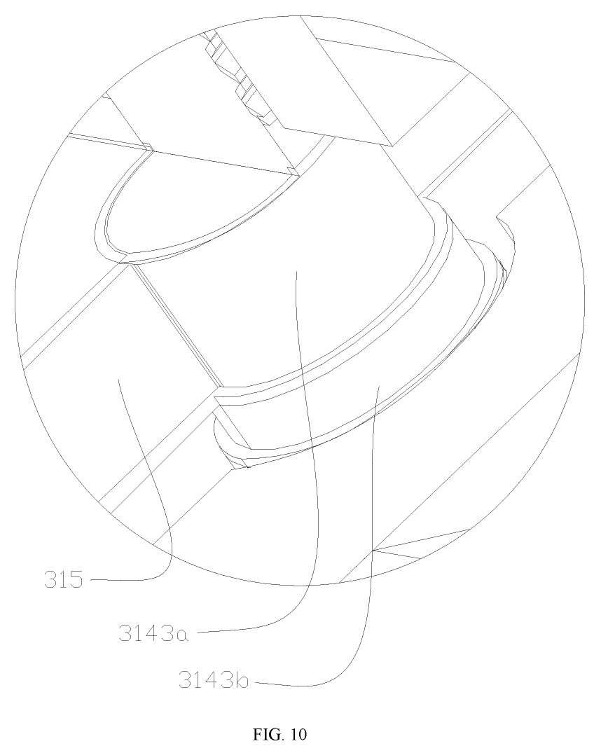

Referring to FIGS. 1 to 10, a tool for connecting a hose 1 and a connector 2, including: a base 100, a hose clamping assembly 200, a connector clamping assembly 300, and a drive assembly 400. The base 100 defines an assembly axis α. The hose clamping assembly 200 is slidably connected to the base 100. The connector clamping assembly 300 is rotatably connected to the base 100 about the assembly axis α. The drive assembly 400 is configured to drive the connector clamping assembly 300 such that the connector clamping assembly 300 rotates about the assembly axis α while moving toward or away from the hose clamping assembly 200.

When the tool is in use, the drive assembly 400 drives the connector clamping assembly 300 to perform rotational movement about the assembly axis α while moving toward or away from the hose clamping assembly 200 in the axial direction, so that the connector 2 synchronously completes axial advancement during the rotation process. This “rotation + linear feed” composite motion mode significantly shortens the assembly time and is particularly suitable for rapid assembly scenarios requiring precision. Compared with traditional manual operation, efficiency is effectively improved. With respect to the assembly axis α , both the rotational movement and the linear movement of the connector clamping assembly 300 are precisely executed along the same axis, ensuring that the docking end faces of the connector 2 and the hose 1 always maintain a minimal coaxiality error, thereby effectively avoiding sealing failure or stress concentration problems caused by angular deviation. The sliding connection design of the hose clamping assembly 200 allows manual adjustment of the clamping distance and clamping force according to the thickness of the hose 1, and cooperates with the rotational feed of the connector 2 to achieve uniform axial pressure loading, thereby guaranteeing consistency in the compression amount at the connecting end of the hose 1, improving the sealing performance and mechanical strength of the connection joint, and further enhancing the user experience.

In this embodiment, the connector clamping assembly 300 includes a clamping housing 310, the drive assembly 400 includes a drive screw 410, the base 100 includes a base threaded hole 110, the clamping housing 310 is fixedly connected to the drive screw 410, and the drive screw 410 is threadedly engaged with the base threaded hole 110. When the drive screw 410 rotates in the base threaded hole 110, the clamping housing 310 drives the connector clamping assembly 300 to rotate about the assembly axis α while approaching or moving away from the hose clamping assembly 200. Through the above structural arrangement, during use, when the drive screw 410 is rotated forward, the clamping housing 310 drives the connector clamping assembly 300 to rotate about the assembly axis α while approaching the hose clamping assembly 200 until the hose 1 and the connector 2 are fully assembled. This structure realizes screw-in docking between the connector 2 and the hose 1 through threaded transmission. When the drive screw 410 rotates, due to its cooperation with the base threaded hole 110, the clamping housing 310 fixed thereon moves along the assembly axis α and rotates synchronously, thereby driving the connector 2 to complete the “rotating while advancing” action. This design integrates linear and rotational movements into a single driving source, simplifying the mechanism. The self-locking property of the threaded pair ensures connection stability, making it suitable for quick connectors of fluid pipelines that require anti-loosening, thereby improving assembly efficiency and reliability. It is worth noting that the base threaded hole 110 is a through hole, and the drive screw 410 is fixedly connected to the clamping housing 310 after passing through the base threaded hole 110.

In this embodiment, the connector clamping assembly 300 further includes a first clamping piece 320 and a second clamping piece 330. The clamping housing 310 includes a fixed housing 311, an upper active housing 312, and a lower active housing 313. The upper active housing 312 and the lower active housing 313 are respectively slidably connected to the upper and lower sides of the fixed housing 311. The upper active housing 312 and the lower active housing 313 slide synchronously in opposite directions. The first clamping piece 320 is connected to the upper active housing 312 and slides synchronously therewith. The second clamping piece 330 is connected to the lower active housing 313 and synchronously follows the sliding of the lower active housing 313. The first clamping piece 320 and the second clamping piece 330 are used to fix the connector 2. Through the arrangement of the above structure, in operation, the user can manually adjust the sliding positions of the upper active housing 312 and the lower active housing 313. Because the sliding directions of the two are synchronized and opposite, when the upper active housing 312 slides in a direction approaching the lower active housing 313, the lower active housing 313 also synchronously slides in the direction approaching the upper active housing 312, thereby causing the first clamping piece 320 and the second clamping piece 330 fixedly connected thereto to synchronously approach each other, and ultimately clamping and fixing the connector 2 between the two. This structure adopts a synchronized centering clamping method, ensuring that during the process in which the connector 2 is clamped, its central axis always remains coincident with the assembly axis α, without requiring the operator to perform additional centering position adjustments, thereby significantly improving clamping precision and efficiency. At the same time, because the sliding distances of the first clamping piece 320 and the second clamping piece 330 always remain equal, the clamping force on the connector 2 is evenly distributed, effectively avoiding clamping deformation or damage caused by unilateral force application. The fixed housing 311 serves as a guiding base, providing stable sliding support for the upper active housing 312 and the lower active housing 313, thereby guaranteeing the repeated clamping precision during repeated disassembly and assembly processes as well as the reliability for long-term use. Through the above design, the user can quickly and accurately complete centered clamping of connectors of different specifications, greatly reducing the centering adjustment time before assembly and improving overall assembly efficiency. It should be noted that the sliding strokes of the upper active housing 312 and the lower active housing 313 can be designed according to the initial spacing of the first clamping piece 320 and the second clamping piece 330 so as to adapt to connectors 2 of different outer diameter sizes. It is worth noting that the inner sides of the first clamping piece 320 and the second clamping piece 330 are configured as a V-shaped structure. This V-shaped structure forms a two-surface contact fit with the connector 2 whose outer contour is hexagonal, and is capable of automatically pushing the center of the connector 2 to the assembly axis α position during the clamping process, thereby realizing self-centering clamping. However, it needs to be particularly noted that the adoption of the V-shaped structure in this embodiment is merely an exemplary implementation manner targeted at hexagonal connectors and does not mean that the inner-side configurations of the first clamping piece 320 and the second clamping piece 330 are limited only to the V-shape. In actual applications, the inner-side configurations of the first clamping piece 320 and the second clamping piece 330 can be flexibly designed according to the outer contour of the clamped connector 2. For a connector 2 with a circular cross-section, an arc-shaped clamping piece may be adopted to achieve enveloping fit; for a connector 2 with a square or rectangular cross-section, a flat clamping piece may be adopted to increase the contact area; for a connector 2 with a special-shaped cross-section, a contoured clamping piece may be adopted to achieve contour matching; and for a connector 2 that has high surface precision requirements or is easily damaged, a clamping piece made of flexible material or an additional soft liner may also be adopted to protect the surface. This modular clamping piece design enables the same clamping mechanism to adapt to connectors 2 of multiple specifications and types by replacing clamping pieces of different shapes, greatly enhancing the versatility and application range of the tool. The operator only needs to loosen the threaded connection to quickly complete the replacement of the clamping pieces, thereby realizing rapid switching from one connector type to another without replacing the entire tool or clamping assembly, which significantly reduces equipment investment costs and operational complexity. Therefore, the arrangement of the V-shaped clamping pieces in this embodiment should be understood as a preferred implementation manner rather than a limitation on the shape of the clamping pieces. Any clamping piece structure that is based on the same clamping principle and undergoes adaptive deformation according to different connector shapes falls within the protection scope covered by the present disclosure.

In this embodiment, the clamping housing 310 further includes a first adjusting component 314. The first adjusting component 314 is rotatably connected to the upper active housing 312 and the lower active housing 313. The first adjusting component 314 controls the upper active housing 312 and the lower active housing 313 to move toward or away from each other through rotation. When the tool is in use, the user only needs to rotate the first adjusting component 314 to precisely control the synchronized sliding of the upper active housing 312 and the lower active housing 313, thereby driving the first clamping piece 320 and the second clamping piece 330 to move toward or away from each other and completing the clamping or releasing operation on the connector 2. This design optimizes the clamping action that originally required two-handed operation or step-by-step adjustment into a single-handed rotational adjustment, significantly improving the convenience and efficiency of operation.

Because the rotation angle of the first adjusting component 314 has a linear correspondence with the sliding distance of the upper active housing 312 and lower active housing 313, the operator can precisely control the clamping stroke according to the outer diameter of the connector 2, thereby realizing fast and repeatable positioning and clamping, which is especially suitable for assembly scenarios in which connectors 2 of different specifications are frequently replaced. At the same time, through the rotational operation of the first adjusting component 314, the clamping force can be kept stable via the self-locking characteristic of the threaded pair. Even with long-term use or when external vibration is encountered, loosening is unlikely to occur, thereby ensuring the positional precision and clamping reliability of the connector 2 during the assembly process.

In this embodiment, the first adjusting component 314 includes a first thread portion 3141 and a second thread portion 3142. The first thread portion 3141 is rotatably connected to the upper active housing 312. The second thread portion 3142 is rotatably connected to the lower active housing 313. Moreover, the first thread portion 3141 and the second thread portion 3142 have opposite thread directions. This ensures that, when the first adjusting component 314 is rotated, the upper active housing 312 and the lower active housing 313 move synchronously toward or away from each other. Through the arrangement of the above structure, during use, the user rotates the first adjusting component 314. Because the thread directions of the first thread portion 3141 and the second thread portion 3142 are opposite, when the first adjusting component 314 rotates, the upper active housing 312 that cooperates with the first thread portion 3141 and the lower active housing 313 that cooperates with the second thread portion 3142 will generate linear motions in opposite directions—that is, the two move synchronously toward each other or move synchronously away from each other. This design realizes the synchronized centering motion of the upper and lower clamping pieces through a single rotational input, ensuring that during the clamping process of the connector 2 its central axis always remains coincident with the assembly axis α without the user needing to perform any additional manual centering adjustment.

This reverse-driving method provides extremely high motion synchronization precision, thereby fundamentally avoiding the connector offset or skew issues that may arise in conventional one-sided clamping approaches, and significantly improving the repeated positioning accuracy and assembly quality. At the same time, the reverse-thread structure has a self-locking characteristic. When the operator stops rotating the first adjusting component 314, the positions of the upper active housing 312 and the lower active housing 313 are immediately locked, and the clamping force is stably maintained without loosening due to external vibration or self-weight, thereby ensuring the positional stability of the connector 2 in the subsequent assembly process. It should be noted that the thread pitches of the first thread portion 3141 and the second thread portion 3142 can be differentially designed according to the requirements of the clamping force so as to adapt to the clamping requirements of connectors 2 of different materials and sizes.

In this embodiment, the clamping housing 310 further includes a first limiting component 315, the first adjusting component 314 further includes an axis limiting portion 3143, and the first thread portion 3141 and the second thread portion 3142 are respectively disposed at two ends of the axis limiting portion 3143. The first adjusting component 314 and the first limiting component 315 are rotatably connected by the axis limiting portion 3143, and the first limiting component 315 cooperates with the axis limiting portion 3143 to restrict axial movement of the first adjusting component 314 when the first adjusting component 314 rotates.

With the foregoing structural arrangement, when the user rotates the first adjusting component 314, the first limiting component 315 constrains the axial position of the first adjusting component 314 via the axis limiting portion 3143. Consequently, the first adjusting component 314 can only rotate about its own axis without undergoing any axial displacement. This design solves the common axial displacement problem encountered in reverse-threaded drive mechanisms—when the first thread portion 3141 and the second thread portion 3142 at the two ends of the first adjusting component 314 respectively cooperate with the upper active housing 312 and the lower active housing 313 and are subjected to axial loads, in the absence of axial limiting, the first adjusting component 314 would move axially under the action of the axial component force generated by the threaded pair during rotation, resulting in clamping-position drift, asynchronous motion, or even jamming. By means of the cooperation between the first limiting component 315 and the axis limiting portion 3143, the axial degree of freedom of the first adjusting component 314 is completely constrained, thereby ensuring the purity and stability of its rotational motion, so that the motion of the upper active housing 312 and the lower active housing 313 strictly follows the preset stroke trajectory and the clamping-position accuracy is fundamentally guaranteed. At the same time, the axial limiting structure effectively reduces the risk of wear of the threaded pair—because the axial position of the first adjusting component 314 is fixed, the threaded engagement of the first thread portion 3141 with the upper active housing 312 and of the second thread portion 3142 with the lower active housing 313 remains in the optimal meshing state at all times, thereby avoiding eccentric-load wear and localized stress concentration caused by axial displacement and significantly prolonging the service life of the mechanism.

In this embodiment, the upper active housing 312 is provided with a first threaded through hole 3121, the lower active housing 313 is provided with a second threaded through hole 3131, the first thread portion 3141 cooperates with the first threaded through hole 3121 thereby achieving a rotatable connection to the upper active housing 312, and the second thread portion 3142 cooperates with the second threaded through hole 3131 so as to realize rotatable connection to the lower active housing 313. With the foregoing structural arrangement, in operation, a user rotates the first adjusting component 314. The first thread portion 3141 rotates inside the first threaded through hole 3121 and the second thread portion 3142 rotates inside the second threaded through hole 3131, and the rotational motion of the first adjusting component 314 is precisely converted into linear motion of the upper active housing 312 and the lower active housing 313 by the meshing transmission of the threaded pair. This design employs a through-type threaded through-hole structure and, compared with a blind hole or partial threaded fit, offers significant advantages in assembly and performance. First, the threaded through-hole is simple to machine and can be formed in a single operation using a standard tap, resulting in low manufacturing cost and controllable precision, which is particularly suitable for mass-production scenarios. Second, the through-hole structure facilitates removal of chips and burrs generated during machining, preventing foreign-matter residues from affecting the smoothness of the threaded fit and ensuring stable, jam-free transmission during long-term use. At the same time, because the threaded through-hole extends through the entire wall thickness of the housing, the engagement length between the first thread portion 3141 and the second thread portion 3142 and the housing is maximized, so that a larger axial load can be borne under the same radial dimension, thereby enhancing the load-bearing capacity and long-term reliability of the clamping mechanism. In addition, the design provides great convenience for installation and maintenance of the first adjusting component 314—the user or assembly personnel can directly observe the threaded meshing state from outside the housing, facilitating alignment adjustment during assembly and status inspection during daily use. When replacement or maintenance of the first adjusting component 314 is required, it is only necessary to unscrew the first adjusting component 314 from the threaded through-hole without disassembling the entire clamping housing 310, thereby significantly reducing the difficulty of maintenance. It is worth noting that the first threaded through hole 3121 and the second threaded through hole 3131 can be adaptively designed according to the thread specifications of the first thread portion 3141 and the second thread portion 3142, and wear-resistant materials or additional lubrication structures may be employed to extend the service life of the threaded pair.

In this embodiment, the first adjusting component 314 further includes a gripping portion 3144 and a controlling portion 3145, the controlling portion 3145 is formed by extending one end of the first adjusting component 314 out of the first threaded through hole 3121 or the second threaded through hole 3131, the gripping portion 3144 is fixedly connected to the controlling portion 3145 and is configured to control rotation of the first adjusting component 314. With the foregoing structural arrangement, in operation, the user can directly grip and rotate the gripping portion 3144, transmitting torque to the first adjusting component 314 via the controlling portion 3145, thereby driving the first thread portion 3141 and the second thread portion 3142 to rotate and realizing synchronous clamping or releasing of the upper active housing 312 and the lower active housing 313. This design extends the adjustment operation point from the body of the first adjusting component 314 to the exterior of the tool, thereby significantly improving the ergonomic performance and convenience of operation. It should be noted that the fixed connection between the gripping portion 3144 and the controlling portion 3145 may adopt various forms such as a key connection, a pin connection, or a threaded connection so as to ensure the reliability of torque transmission and the stability of long-term use.

In this embodiment, the controlling portion 3145 is provided with a connecting threaded hole 3145a, and the gripping portion 3144 is provided with a threaded fastener 3144a that matches the connecting threaded hole 3145a. The threaded fastener 3144a is threadedly engaged with the connecting threaded hole 3145a so that the gripping portion 3144 is fixedly connected to the controlling portion 3145. With the above structural arrangement, during assembly, the threaded fastener 3144a on the gripping portion 3144 is screwed into the connecting threaded hole 3145a of the controlling portion 3145, thereby securely fixing the two components together. The threaded connection method offers significant advantages in terms of connection reliability, maintainability, and process economy. First, the threaded connection is a high-strength, high-reliability detachable connection; the meshing of the threaded fastener 3144a with the connecting threaded hole 3145a generates sufficient axial preload force, ensuring that the gripping portion 3144 remains tightly fixed to the controlling portion 3145 even under frequent rotational operations and possible vibration or impact, without loosening or detachment. This guarantees the stability of torque transmission and the safety of operation. Second, the detachable nature of the threaded connection provides great convenience for maintenance and replacement. When the gripping portion 3144 becomes worn or damaged after prolonged use, or when it is necessary to replace it with a gripping portion of a different specification or form to suit a new operating scenario, the user can simply unscrew the gripping portion in the reverse direction to remove the old part and install a new one without replacing the entire first adjusting component 314, thereby significantly reducing usage cost and maintenance downtime. In addition, the connecting threaded hole 3145a is machined directly on the controlling portion 3145, eliminating the need for additional connecting parts or complex mounting structures. The overall design is compact and concise without increasing the external dimensions or weight of the tool. Furthermore, as a standardized connection method, threaded connection has matured processing technology and low cost; the threaded fastener 3144a can be procured as a standard part, further reducing manufacturing cost.

In this embodiment, the upper active housing 312 is provided with an upper sliding groove 3122, the lower active housing 313 is provided with a lower sliding groove 3132, and the fixed housing 311 is provided with two slide blocks 3111. The upper sliding groove 3122 and the lower sliding groove 3132 mate with two slide blocks 3111, respectively, such that the upper active housing 312 and the lower active housing 313 are slidably connected to the upper and lower sides of the fixed housing 311. With the above structural arrangement, during use the upper active housing 312 slides on the upper-side slide block 3111 of the fixed housing 311 by means of the upper sliding groove 3122, while the lower active housing 313 slides on the lower-side slide block 3111 of the fixed housing 311 by means of the lower sliding groove 3132. The two housings thereby moving smoothly along a preset sliding trajectory under the guiding restraint of the two slide blocks 3111. The slide-guide structure adopted here furnishes precise motion constraint and stable load-bearing support for the sliding of the upper and lower active housings. It is worth noting that wear-resistant liners or lubricating structures may be additionally provided, as required, between the sliding grooves and the slide blocks to further prolong the service life of the sliding mechanism and enhance the smoothness of motion.

In this embodiment, the first clamping piece 320 is fixedly connected to the upper active housing 312 by threaded connection, and the second clamping piece 330 is fixedly connected to the lower active housing 313 by threaded connection. With the above structural arrangement, during use the first clamping piece 320 and the second clamping piece 330 form a firm connection with the respective upper active housing 312 and the lower active housing 313 through threaded fastening and can withstand the clamping reaction force without loosening or displacement. The adoption of threaded connection as the fixing mode for the clamping pieces offers marked advantages in maintainability, economy, and adaptability.

In this embodiment, the axis limiting portion 3143 includes a connecting shaft section 3143a that is rotatably connected to the first limiting component 315 and limiting shaft sections 3143b located at both ends of the connecting shaft section 3143a. The diameter of the connecting shaft section 3143a is smaller than the diameter of the limiting shaft sections 3143b. With the above structural arrangement, in use the first limiting component 315 mates with the connecting shaft section 3143a to realize a rotatable connection while the limiting shaft sections 3143b located at both ends of the connecting shaft section 3143a. By virtue of their larger diameter, form an axial stop against the first limiting component 315, thereby restricting axial movement of the first adjusting component 314 relative to the first limiting component 315. The stepped-shaft structure is adopted, thereby realizing, in a concise and ingenious manner, the dual functions of rotational freedom and axial locking.

In this embodiment, the first limiting component 315 includes a limiting through slot 3151. The connecting shaft section 3143a and the limiting shaft sections 3143b respectively mate with the limiting through slot 3151 so that the first limiting component 315 is rotatably connected to the first adjusting component 314 while simultaneously restricting axial movement of the first adjusting component 314. With the above structural arrangement, in use the limiting through slot 3151 of the first limiting component 315 is sleeved onto the axis limiting portion 3143 of the first adjusting component 314, such that the connecting shaft section 3143a is accommodated inside the limiting through slot 3151 while the limiting shaft sections 3143b are located outside on both sides of the limiting through slot 3151. By means of this connecting relationship the first limiting component 315 simultaneously realizes the dual functions of rotatable connection and axial limiting with respect to the first adjusting component 314. The through-slot-type limiting structure is adopted, thereby solving, in a highly integrated form, the synergistic problem of rotational support and axial constraint.

In this embodiment, the positions of the upper active housing 312 and the lower active housing 313 remain, throughout the sliding process, in a state that is always symmetric with respect to the assembly axis α. With the above structural arrangement, in use, no matter to what position the upper active housing 312 and the lower active housing 313 slide, the two always maintain a strict geometric symmetry relationship with respect to the assembly axis α—that is, the distance between the upper active housing 312 and the assembly axis α is always equal to the distance between the lower active housing 313 and the assembly axis α. This design feature is realized through the collective action of the aforementioned reverse-thread drive mechanism, the slide-guide mechanism, and the first limiting component, thereby furnishing a fundamental centering guarantee for the clamping of the connector 2.

In this embodiment, the drive assembly 400 further includes a drive handle 420, the drive handle 420 is movably connected to the drive screw 410, the drive handle 420 being used to drive the drive screw 410 to rotate. With the above structural arrangement, when in use the user grips and rotates the drive handle 420, transmitting torque to the drive screw 410 through the movable connection between the drive handle 420 and the drive screw 410 so that the drive screw 410 rotates in the base threaded hole 110, thereby driving the connector clamping assembly 300 to rotate about the assembly axis α and to advance axially, thereby completing the connection between the connector 2 and the hose 1. By incorporating the movable drive handle 420, the present design optimizes operational convenience, torque transmission efficiency, and spatial adaptability.

In this embodiment, the drive screw 410 includes a threaded drive portion 411 and a handle mounting portion 412, the handle mounting portion 412 being provided with a handle mounting hole 4121; the drive handle 420 includes a connecting portion 421 and a grip limiting portion 422, the grip limiting portion 422 being located at both ends of the connecting portion 421, the connecting portion 421 being movably connected to the handle mounting hole 4121. With the above structural arrangement, in use the user assembles the connecting portion 421 of the drive handle 420 into the handle mounting hole 4121 and, by gripping and turning the grip limiting portion 422, transmits torque through the connecting portion 421 to the handle mounting portion 412 and thence drives the threaded drive portion 411 to rotate in the base threaded hole 110, achieving the combined rotary and axial feed motion of the connector clamping assembly 300. By functionally partitioning the drive screw 410 and optimizing the configuration of the drive handle 420, the design achieves multiple improvements in transmission efficiency, operational comfort, and spatial adaptability.

In this embodiment, the hose clamping assembly 200 further includes a second adjusting component 210, a first clamping component 220, and a second clamping component 230. The base 100 includes a guide rail 120, the guide rail 120 is arranged in a direction perpendicular to the assembly axis α, the first clamping component 220 and the second clamping component 230 are slidably connected to the guide rail 120, and the second adjusting component 210 is used to adjust the spacing between the first clamping component 220 and the second clamping component 230. With the above structural arrangement, when in use the user actuates, by means of the second adjusting component 210, the first clamping component 220 and the second clamping component 230 slide toward or away from each other on the guide rail 120 that is perpendicular to the assembly axis α, thereby rapidly adjusting the spacing between them to accommodate hoses 1 of different hose diameters and to achieve reliable clamping. The design enables the hose clamping assembly 200 to flexibly adapt to hoses of various specifications, markedly enhancing the versatility of the tool. At the same time, the clamping components slide in the direction perpendicular to the assembly axis α, ensuring that after the hose 1 is clamped its central axis naturally aligns with the assembly axis α without the need for additional centering adjustment; in coordination with the rotary feed motion of the connector 2, the hose 1 remains stable in the clamped state, guaranteeing the coaxiality alignment precision of the connector 2 and the hose 1 during assembly and effectively improving assembly quality and efficiency. In addition, the rail-type sliding structure provides smooth guidance and reliable load bearing, so that the clamping force is uniformly distributed, hose deformation or damage is avoided, and operational stability is further enhanced.

In this embodiment, the hose clamping assembly 200 further includes a second limiting component 240. The second limiting component 240 is disposed between the first clamping component 220 and the second clamping component 230. The second limiting component 240 is used to restrict movement of the second adjusting component 210 in the direction parallel to the guide rail 120. The first clamping component 220 includes a first threaded hole 221, the second clamping component 230 includes a second threaded hole 231, the second adjusting component 210 includes a third thread portion 211 and a fourth thread portion 212. The third thread portion 211 is threadedly connected to the first threaded hole 221, the fourth thread portion 212 is threadedly connected to the second threaded hole 231, and the thread directions of the third thread portion 211 and the fourth thread portion 212 are opposite. With the above structural arrangement, when in use. the user rotates the second adjusting component 210; because the thread directions of the third thread portion 211 and the fourth thread portion 212 are opposite, the first clamping component 220 and the second clamping component 230 that are threadedly connected thereto slide synchronously toward or away from each other on the guide rail 120, thereby realizing rapid clamping or release of hoses 1 of different hose diameters. This reverse-thread drive mode ensures that the motion of the first clamping component 220 and the second clamping component 230 always remains synchronized and symmetric with respect to the assembly axis α, so that after the hose 1 is clamped its central axis automatically coincides with the assembly axis α without requiring manual centering by the operator, markedly improving assembly precision and efficiency. At the same time, the second limiting component 240 is disposed between the first clamping component 220 and the second clamping component 230 and, through limiting cooperation with the second adjusting component 210, effectively constrains axial movement of the second adjusting component 210 in the direction parallel to the guide rail 120, ensuring that it remains positionally stable during rotation and preventing clamping offset or thread jamming caused by axial displacement, thereby further enhancing the motion precision and long-term reliability of the clamping mechanism.

In this embodiment, the second adjusting component 210 further includes a limiting annular groove 213, the limiting annular groove 213 being disposed between the third thread portion 211 and the fourth thread portion 212; the second limiting component 240 includes a connecting end 241 and a limiting end 242, the connecting end 241 being fixedly connected to the base 100, the limiting end 242 cooperating with a portion of the contour of the limiting annular groove 213; the second adjusting component 210 further includes a control handle 214, the control handle 214 being used to control rotation of the second adjusting component 210 and thereby control the first clamping component 220 and the second clamping component 230 to move toward or away from each other. With the above structural arrangement, in use the user grips and rotates the control handle 214 to drive the second adjusting component 210 to rotate; because the thread directions of the third thread portion 211 and the fourth thread portion 212 are opposite, the first clamping component 220 and the second clamping component 230 that are threadedly connected thereto slide synchronously toward or away from each other on the guide rail 120, thereby realizing rapid clamping or release of the hose 1. During this process the limiting annular groove 213 mates with the limiting end 242 of the second limiting component 240—the limiting end 242 engages a portion of the outer contour of the limiting annular groove 213, thereby forming axial constraint on the second adjusting component 210 so that it can only rotate about its own axis during rotation and cannot undergo axial displacement in the direction parallel to the guide rail 120. It is worth noting that the controlled clearance between the limiting end 242 and the limiting annular groove 213 must be precisely controlled so as to ensure both smooth rotation and the avoidance of axial displacement caused by excessive clearance.

The foregoing descriptions provide one or more embodiments in conjunction with specific content and do not intend that the specific implementation of the present disclosure is limited only to these descriptions. Any approximations or similarities to the methods, structures, and the like of the present disclosure, or any technical deductions or substitutions made on the premise of the inventive concept of the present disclosure, shall be deemed to fall within the protection scope of the present disclosure.

What is claimed is:

1. A tool for connecting a hose and a connector, comprising:
a base defining an assembly axis;
a hose clamping assembly slidably connected to the base;
a connector clamping assembly rotatably connected to the base for rotation about the assembly axis; and
a drive assembly configured to drive the connector clamping assembly, such that the connector clamping assembly rotates about the assembly axis while moving toward or away from the hose clamping assembly.

2. The tool of claim 1, wherein the connector clamping assembly comprises a clamping housing, the drive assembly comprises a drive screw, the base comprises a base threaded hole;
the clamping housing is fixedly connected to the drive screw, and the drive screw is rotatably connected to the base threaded hole;
wherein, when the drive screw rotates, the clamping housing drives the connector clamping assembly to rotate about the assembly axis while moving toward or away from the hose clamping assembly.

3. The tool of claim 2, wherein the connector clamping assembly further comprises a first clamping piece and a second clamping piece, the clamping housing comprises a fixed housing, an upper active housing and a lower active housing;
the upper active housing and the lower active housing are respectively slidably connected to upper and lower sides of the fixed housing, and the upper active housing and the lower active housing slide synchronously in opposite directions;
the first clamping piece is connected to the upper active housing and slides synchronously therewith, the second clamping piece is connected to the lower active housing and slides synchronously therewith, and the first clamping piece and the second clamping piece are configured to fix the connector.

4. The tool of claim 3, wherein the clamping housing further comprises a first adjusting component, the first adjusting component is rotatably connected to the upper active housing and the lower active housing, and the first adjusting component is configured to control the upper active housing and the lower active housing to move toward or away from each other by rotation.

5. The tool of claim 4, wherein the first adjusting component comprises a first thread portion and a second thread portion, the first thread portion is rotatably connected to the upper active housing, the second thread portion is rotatably connected to the lower active housing; and
thread directions of the first thread portion and the second thread portion are opposite; when the adjusting component rotates, the upper active housing and the lower active housing move toward or away from each other synchronously.

6. The tool of claim 5, wherein the clamping housing further comprises a first limiting component, the first adjusting component further comprises an axis limiting portion, the first thread portion and the second thread portion are respectively disposed at two ends of the axis limiting portion;
the first adjusting component and the first limiting component are rotatably connected via the axis limiting portion, and the first limiting component and the axis limiting portion cooperate with each other to restrict axial movement of the first adjusting component during rotation.

7. The tool of claim 5, wherein the upper active housing is provided with a first threaded through hole, the lower active housing is provided with a second threaded through hole;
the first thread portion is cooperated with the first threaded through hole to realize rotatable connection to the upper active housing, and the second thread portion is cooperated with the second threaded through hole to rotatably connect to the lower active housing.

8. The tool of claim 7, wherein the first adjusting component further comprises a gripping portion and a controlling portion, the controlling portion extends from one end of the first adjusting component through either the first threaded through hole or the second threaded through hole, the gripping portion is fixedly connected to the controlling portion, and the gripping portion is configured to control the first adjusting component to rotate.

9. The tool of claim 8, wherein the controlling portion is provided with a connecting threaded hole, the gripping portion is provided with a threaded fastener that matches the connecting threaded hole; and
the threaded fastener is threadedly engaged with the connecting threaded hole, such that the gripping portion is securely fixed to the controlling portion.

10. The tool of claim 3, wherein the upper active housing is provided with an upper sliding groove, the lower active housing is provided with a lower sliding groove, the fixed housing is provided with two slide blocks; and
the upper sliding groove and the lower sliding groove are configured to cooperate with the two slide blocks, respectively, allowing the upper active housing and the lower active housing to be slidably mounted on upper and lower sides of the fixed housing, respectively.

11. The tool of claim 3, wherein the first clamping piece is fixed to the upper active housing and the second clamping piece is fixed to the lower active housing, each by a threaded connection.

12. The tool of claim 6, wherein the axis limiting portion comprises a connecting shaft section rotatably connected to the first limiting component and limiting shaft sections located at both ends of the connecting shaft section.

13. The tool of claim 12, wherein a diameter of the connecting shaft section is smaller than that of the limiting shaft sections.

14. The tool of claim 13, wherein the first limiting component comprises a limiting through slot, and the connecting shaft section and the limiting shaft sections respectively cooperate with the limiting through slot, such that the first limiting component is rotatably connected to the first adjusting component while restricting axial movement of the first adjusting component.

15. The tool of claim 3, wherein positions of the upper active housing and the lower active housing remain symmetric with respect to the assembly axis at all times during sliding.

16. The tool of claim 2, wherein the drive assembly further comprises a drive handle movably connected to the drive screw, and the drive handle is configured to drive the drive screw to rotate.

17. The tool of claim 2, wherein the drive screw comprises a threaded drive portion and a handle mounting portion, the handle mounting portion is provided with a handle mounting hole; the drive handle comprises a connecting portion and grip limiting portions, the grip limiting portions are located at both ends of the connecting portion, and the connecting portion is movably connected to the handle mounting hole.

18. The tool of claim 1, wherein the hose clamping assembly comprises a second adjusting component, a first clamping component and a second clamping component, the base comprises a guide rail, the guide rail is arranged perpendicular to the assembly axis, the first clamping component and the second clamping component are slidably connected to the guide rail, and the second adjusting component is configured to adjust a distance between the first clamping component and the second clamping component.

19. The tool of claim 18, wherein the hose clamping assembly further comprises a second limiting component, the second limiting component is disposed between the first clamping component and the second clamping component, and the second limiting component is configured to restrict movement of the second adjusting component in a direction parallel to the guide rail;
the first clamping component comprises a first threaded hole, the second clamping component comprises a second threaded hole, the second adjusting component comprises a third thread portion and a fourth thread portion, the third thread portion is threadedly connected to the first threaded hole, the fourth thread portion is threadedly connected to the second threaded hole, and thread directions of the third thread portion and the fourth thread portion are opposite.

20. The tool of claim 19, wherein the second adjusting component further comprises a limiting annular groove disposed between the third thread portion and the fourth thread portion; and
the second limiting component comprises a connection end and a limiting end, the connection end is fixedly connected to the base, and the limiting end matches part of an outer contour of the limiting annular groove; and
the second adjusting component further comprises a control handle, and the control handle is configured to control the second adjusting component to rotate, thereby controlling the first clamping component and the second clamping component to move toward or away from each other.
